(19) United States
(12) Patent Application Publication
(10) Pub. No.: US 2012/0287345 A1
(43) Pub. Date: Nov. 15, 2012

(54) System and Method for Automatically Tuning Video Signals

(75) Inventors: Te Chien Lien, Hsin-chu City (TW); Hsien Hui Lai, Hsin-chu City (TW)

(73) Assignee: CMSC, INC., Hsin-Chu City (TW)

(21) Appl. No.: 13/192,659

(22) Filed: Jul. 28, 2011

(30) Foreign Application Priority Data
May 13, 2011 (TW) 100116914

(51) Int. Cl. H04N 5/50; H04N 5/38

(52) U.S. Cl. 348/723; 348/731; 348/E05.097

(57) ABSTRACT

This invention discloses an automatically signal-tuning system for using in video signal transmission. The system can use the auto-tuning function in video transmission circuit to make the system automatically detect the extents of frequency loss and delay affected by a transmitting cable and to adjust the received signal to approximate to the original transmitted signal once system reboot and/or transmitting cable hot-plugging. The compensation for the signal frequency loss and the signal delay is by comparing and analyzing the attenuation and the delay values to provide the video signal on the transmitting cable to be automatically adjusted to the optimized response value.

### BACKGROUND OF THE INVENTION

1. Field of the Invention

This invention generally relates to the field of compensation for video signals, and more particularly, to a system and method for automatically tuning video signals.

2. Description of the Prior Art

In a variety of personal computer systems, such as Windows PCs, SUN workstations, Apple Computer, the image source of the analog color video signal, in general use, is connected in the indoor environment within no more than 2 meters, and hence, the attenuation and delay problems would not be found.

However, under special requirements and/or securities concerned, such as the host server must be kept in the computer room and let all users to use the terminal in the remote site which is far away from it (10 to 300 meters). In this application, a transmission line with a number of conductors, such as CAT5 cable (its first pair line to third pair line having the differential signals of RGB video signals respectively), is used to transmit the signal with differential signals to the displayer at remote receiving site. When video signals were transmitted via a cable over 300 meters to the displayer at remote receiving site, the RGB video signals usually become distorted and delayed. This is induced by the low-pass frequency characteristics of individual conductors which were used to transmit video signals and there is a little difference in electrical properties and length. This makes the displayer at the remote receiving site show the results, such as color offset, trailing smear and image ambiguous.

The signal attenuation is caused by the frequency domain characteristics of the cable and it is a non-linear distortion. The cable is essentially a kind of low-pass material on frequency domain. The high-frequency harmonics of the video signal will be lost which was caused from attenuation of cable, such as the harmonic components on rising edge of pulse will get mitigation or loss.

The signal time delay is resulted from the time domain characteristics of the cable. Because there are differences on the length and the material of the conductors, and it causes the time delay as the signal transmitted to the remote receiving site, and shows RGB signals arriving at the displayer at different time. The extent of the differences will become serious as the cable getting longer.

For these two major problems mentioned above, in the prior art, the receiving site requires user to manually adjust, or use keyboard to adjust the system for the intensity of the amplitude, equalization and propagation delay in order to obtain just a slight improvement. However, the effect of the long-distance cable still has room for improvement.

Many prior arts are made and related only for the compensation of the signal time delay. For example, the U.S. Pat. No. 7,456,696, proposes a signal delay compensation circuit. The variable delay line circuit, the phase detector and the controller are used at the receiving site of cable for signal compensation. The oscillator generates clock signal at the transmitting site of cable, and the multiplexer sends one of the analog signal or oscillator signal to the transmitting line. The analog signal is selected in normal usage, and the oscillator signal is transmitted on the cable during the testing process. The disadvantage of this patent is that two delay lines are required for each path, and it makes the double cost of the construction. Moreover, it is lacking of the control and the adaptation for the low-pass characteristics of longer or shorter cable.

For another example, the U.S. Pat. No. 7,277,104, provides a device for reducing and judging the delay among the color video signals transmitted on several different video cables. On the remote receiving unit, each delay detection circuit includes the pulse separation detection circuit and the phase detection circuit to calculate the delay amount. For the delay compensation testing, the normal video transmission need to be interrupted, and the detecting signals for the delay and phase are included to determine the delay compensation value.

Therefore, in the prior art, some of them need to be manually adjusted one by one, others have higher cost and lacking of the adaptability for the longer cable or shorter cable, or some of them break the video signal transmission by the testing process and cannot be used in high definition video.

In view of the drawbacks mentioned with the prior art of video signal tuning, there is a continuous need to develop a new and improved system for automatically tuning video signals that overcomes the shortages associated with the prior art of video signal tuning. The advantages of the present invention are that it can solve the problems mentioned above.

### SUMMARY OF THE INVENTION

In accordance with the present invention, the system and method for automatically tuning video signals substantially obviate one or more of the problems resulted from the limitations and disadvantages of the prior arts mentioned in the background.

The embodiments of the present invention provide a feedback circuit to be used for compensating the signal distortion in frequency domain and the signal delay in time domain. The attenuation and the delay occur on the paths that signals pass by, and hence, the present invention is related to the system and method for correcting the signal distortion during the transmitting process. Herein, the attenuation in frequency domain can be processed by selecting and amplifying the attenuated frequency to retrieve the signals which were sent out from the transmitting site. The time delay among several signals can be processed by delaying the leading signal to meet the lagging signal and make all the signals synchronously.

The present invention discloses a system for automatically tuning video signals. The system includes a transmitter module and a receiver module. The transmitter module sends a first set of video signals in a first mode period, and sends a second set of video signals in a second mode period. The receiver module receives and digitalizes the first set of analog video signals into digital signals, comparing the digital signals with a set of predetermined signals and then calculate a plurality of equalizing gains for a differential receiver to equalize and amplify a plurality of primary signals of the first set of video signals, detecting the delay extents of the plurality of primary signals of the first set of video signals to calculate a plurality of delay values for a delayer to feed back and adjust the delay extents of the plurality of primary signals of the first set of video signals, and sends a finish command to the transmitter module. Herein, the transmitter module changes from the first mode period to the second mode period after receiving the command, and then the receiver module will receive the second set of video signals. After that, the differential receiver equalizes and amplifies a plurality of primary signals of the second set of video signals according to the plurality of equalizing gains, and adjusts the delay extents of the plurality of primary signals of the second set of video signals according to the plurality of delay values.

The present invention provides a method for automatically tuning video signals. The method includes sending a first set of video signals by a transmitter module in a first mode period and sending a second set of video signals by the transmitter module in a second mode period; receiving and digitalizing the first set of video signals into digital signals by a receiver module and comparing the digital signals with a set of predetermined signals to calculate a plurality of equalizing gains; equalizing and amplifying a plurality of primary signals of the first set of video signals by a differential receiver according to the plurality of equalizing gains; detecting the delay extents of the plurality of primary signals of the first set of video signals by the receiver module to calculate a plurality of delay values; feeding back and adjusting the delay extents of the plurality of primary signals of the first set of video signals by a delayer; and sending a finish command by the receiver module to the transmitter module. Herein, the transmitter module changes from the first mode period to the second mode period after receiving the command, and then the receiver module receives the second set of video signals. Herein, the differential receiver equalizes and amplifies a plurality of primary signals of the second set of video signals according to the plurality of equalizing gains, and adjusts the delay extents of the plurality of primary signals of the second set of video signals according to the plurality of delay values.

The present invention discloses a receiver module for automatically tuning video signal system. The receiver module includes a detecting controller and a microprocessor. The detecting controller receives a first set of video signals from a differential receiver, digitalizing the first set of video signals into digital signals, comparing the digital signals with a set of predetermined signal to calculate a plurality of equalizing gains, and detects the delay extents of a plurality of primary signals of the first set of video signals to calculate a plurality of delay values. The microprocessor receives the plurality of equalizing gains, controlling the differential receiver to equalize and amplify the plurality of primary signals of the first set of video signals according to the plurality of equalizing gains, receiving the plurality of delay values, controlling a delayer to feed back and adjust the delay extents of the plurality of primary signals of the first set of video signals from the differential receiver according to the plurality of delay values, and sends a finish command to a transmitter module.

The present invention provides a receiving method for automatically tuning video signal system. The receiving method includes receiving a first set of video signals from a differential receiver and digitalizing the first set of video signals into digital signals by a detecting controller, comparing the digital signals with a set of predetermined signals to calculate a plurality of equalizing gains, detecting the delay extents of a plurality of primary signals of the first set of video signals to calculate a plurality of delay values; and receiving the plurality of equalizing gains by a microprocessor, controlling the differential receiver to equalize and amplify the plurality of primary signals of the first set of video signals according to the plurality of equalizing gains, receiving the plurality of delay values, controlling a delayer to feed back and adjust the delay extents of the plurality of primary signals of the first set of video signals from the differential receiver according to the plurality of delay values, and sending a finish command.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 illustrates one preferred system embodiment in accordance with the present invention;

FIG. 2A illustrates one preferred transmitter module embodiment in accordance with the present invention;

FIG. 2B illustrates one preferred receiver module embodiment in accordance with the present invention;

FIG. 3 illustrates preferred waveforms for automatically signal-tuning embodiment in accordance with the present invention;

FIG. 4 depicts a flowchart for one preferred signal-transmitting embodiment in accordance with the present invention; and

FIG. 5 depicts a flowchart for one preferred signal-receiving and signal-tuning embodiment in accordance with the present invention.

### DETAILED DESCRIPTION OF THE PREFERRED EMBODIMENTS

Some embodiments of the present invention will now be described in greater detail. Nevertheless, it should be noted that the present invention can be practiced in a wide range of other embodiments besides those explicitly described, and the scope of the present invention is expressly not limited except as specified in the accompanying claims.

Moreover, some irrelevant details are not drawn in order to make the illustrations concise and to provide a clear description for easily understanding the present invention.

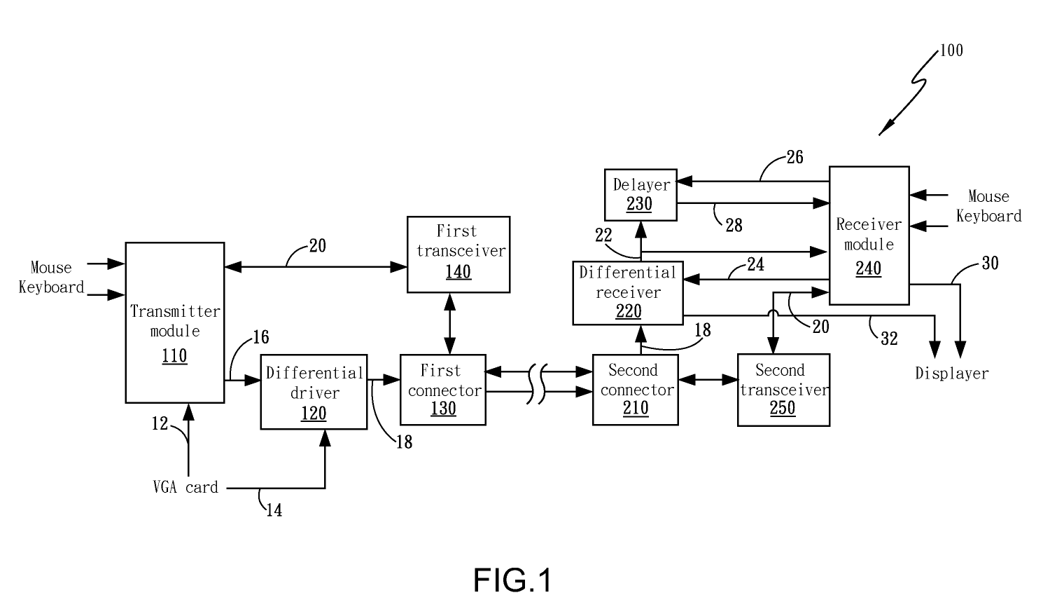

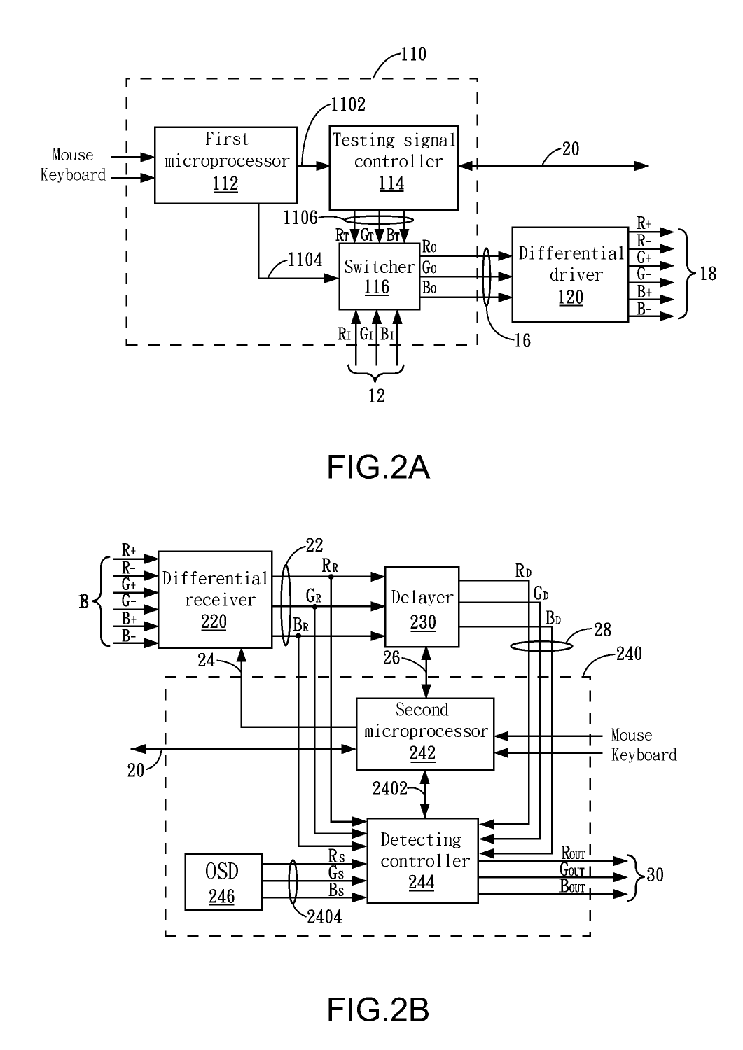

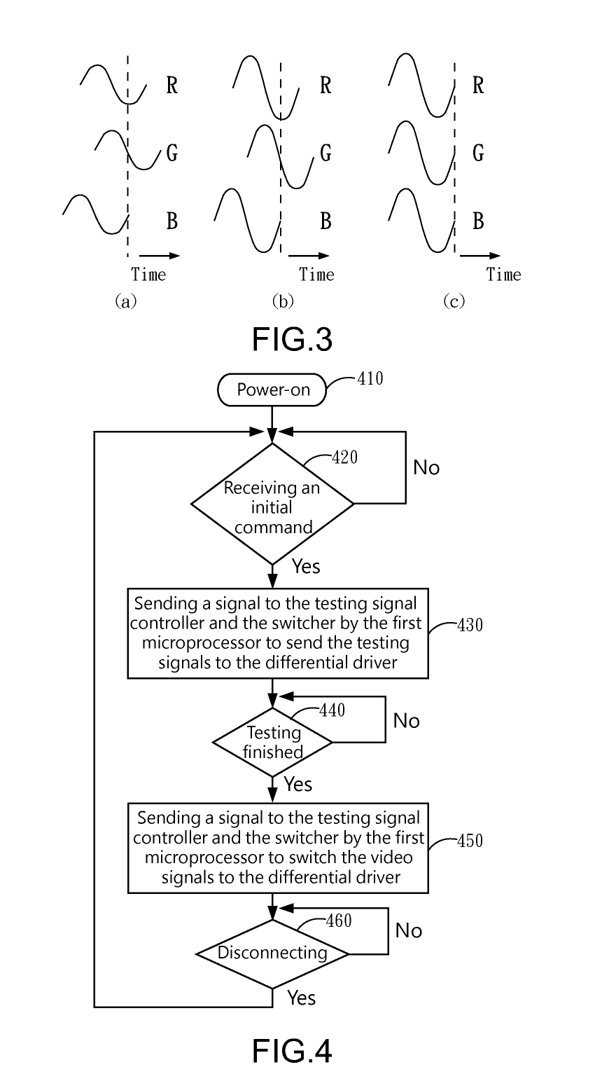

The present invention provides a method for automatically tuning the related delays of the video signals on the transmitting cable at a receiver to make the delays of the primary signals, such as RGB video signals will be fully equal to each other. Referring to FIG. 1, a transmitter module 110 is equipped at the transmitting site of a transmitting cable. The transmitter module 110 can generate at least one set of oscillator testing signals having a plurality of synchronous primary signals, such as RGB video signals with the same amplitude and known frequency, such as those shown on (c) of FIG. 3. The transmitter module 110 routinely stars a tuning process once the transmitting cable linked to. A switcher 116 (FIG. 2A) selects and passes the set of oscillator testing signals to the receiving site of the transmitting cable from the transmitting site. By adjusting a delay circuit at the receiving site, the related delays in the set of oscillator testing signals can be fully equal to each other.

The preferred embodiments in accordance with the present invention provide the compensation for the signal attenuation and delay through a set of feedback circuits, providing circuits and methods used to compensate the signal distortion in the frequency domain and time domain on the transmitting cable at the receiving site, and calculate equalizing gains and the parameters setting for the delayer to improve the signal quality at the receiver site of the transmitting cable. As the testing oscillator signals arriving, the receiving site adjusts the compensation for frequency domain first, so that the front-edge of the signal can be definitely identified by higher frequency components. In practical uses, replacing square waves with sine waves in testing oscillator signal, the influence caused by the low-pass characteristic of the transmitting cable can be avoided. Because using square testing oscillator signal to tune the parameters will make the high frequency be excessively amplified by the receiver controller and this leads to serious signal distortion. Conversely, using sine wave testing oscillator signal can avoid the low-pass essence of the transmitting cable, and get more precise parameters for equalizing gains.

Referring to FIG. 2B, an adjustable delay line circuit is used at the receiving site. A second microprocessor 242 and a detecting controller 244 are connected after a delayer 230. The detecting controller 244 is used to measure the extent of transmitting delay on the transmitting cable and makes the result be digitalized. The second microprocessor 242 adjusts the adjustable delay line circuit according to the result measured by the detecting controller 244 to make the related delays among the primary signals on the transmitting cable minimized. Several signals that are asynchronous in time domain can be received by the displayer at the same time by delaying the leading signal to wait the lagging signal.

Referring to (a) of FIG. 3, it shows the testing signals that are unprocessed by the receiving site have the appearances of attenuation and delay. (b) of FIG. 3 shows the testing signals are amplified and compensated in frequency domain, and (c) of FIG. 3 shows the testing signals are retrieved to the original signals of transmitting site through further compensation in delay.

Referring to FIG. 4, the switching and processing flows for the testing signals at the transmitting site are illustrated. In step 410, the test signal controller 114 (FIG. 2A) startups testing signals once receiving an initial command from the transmitting cable after power-on, such as the fourth pair of CAT5 for RS485 serial transmitting cable. In step 430, the switcher 116 (FIG. 2A) selects the testing signals to the differential driver 120 (FIG. 2A). The test signal controller 114 (FIG. 2A) selects the different frequency testing signal according to the instruction at the receiving site to meet the application range for video signal. In step 440, the test signal controller 114 commands the switcher 116 to select and send video signals to the differential driver 120 after receiving a finish command from the receiving site, and the testing flow is finished here. The testing flow will be re-startup once the transmitting cable reconnecting and/or the system reboot.

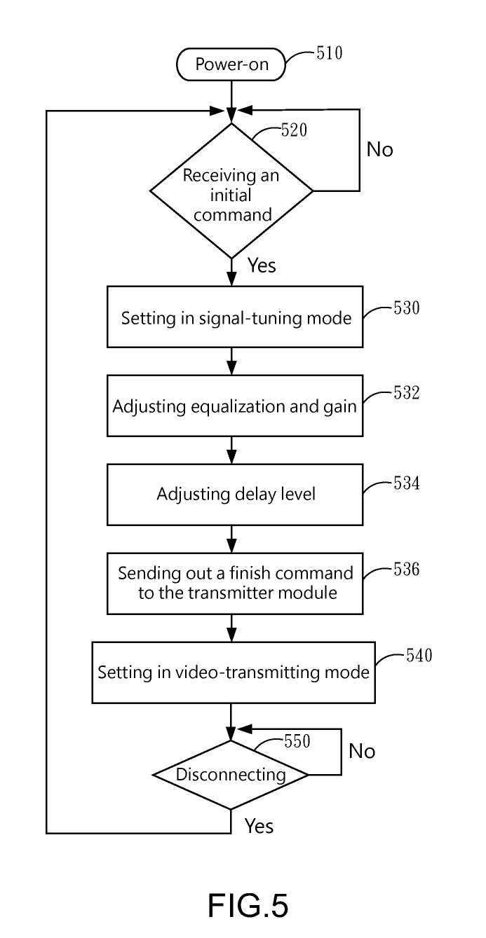

Referring to FIG. 5, the flows for equalizing, amplifying, and delay compensation are illustrated. In steps 510 and 520, after system power-on, the differential receiver 220 (FIG. 2B) transforms the testing signals to single-end type, such as those shown on (a) of FIG. 3, after receiving the testing signals in differential type from the transmitting cable. In steps 530 and 532, the detecting controller 244 (FIG. 2B) samples and digitalizes the testing signals, commanding the differential receiver 220 to roughly equalize and amplify the testing signals to make the testing signals be able to be further adjusted in delay as those shown on (b) of FIG. 3 after calculating and comparing to. In step 534, the detecting controller 244 and the second microprocessor 242 (FIG. 2B) sends the delay parameters related to each transmitting line to the delayer 230 (FIG. 2B) after calculating the delay extent of line to line. The output of the delayer 230 is fed back to the detecting controller 244 through a feedback path to be compared and determined to whether being advance adjusted by the delayer 230 or being able to be used directly, so that the output of the delayer 230 can be adapted to the length characteristic of transmitting cable to prevent the video signals from attenuation and distortion. For example, within 2-3 meters, the output of the delayer 230 could be unnecessary except being equalized only with connecting in a transmitting cable for a better quality. Judging by the feedback signal, the detecting controller 244 will calculate the optimized gains and delay values for providing the differential receiver 220 and the delayer 230 if the feedback signal needs to be further adjusted. The final signals received by the detecting controller 244 will be like the original signal shown on (c) of FIG. 3. In step 536, the second microprocessor 242 sends a finish command to the test signal controller 114 (FIG. 2A) at the transmitting site. In step 540, the first microprocessor 112 (FIG. 2A) of the transmitter module 110 (FIG. 2A) commands the switcher 116 (FIG. 2A) to switch and pass the normal video signals to the differential driver 120 (FIG. 2A). The normal video signals are sent to the differential driver 220 from the transmitting cable, such as CAT5 cable. The second microprocessor 242 at the receiving site will make the detecting controller 244 to use the modification results of the detecting process mentioned above to make the video signals be compensated for transmitting attenuation and delay and then output to the displayer. The process mentioned above will not be executed again until the transmitting cable being reconnected and/or the system being rebooted. Herein, the parameters set for equalizing, amplifying, and delayer will be stored in a memory and then the automatically tuning process is finished. The data and the settings will be stored by the automatically tuning process and can be used for the compensation to the next normal video signals came from a video source.

In the embodiments of the present invention, the detecting controller 244 can calculate and analyze the testing signals with the same amount of attenuation and delay of the video signals, and dynamically adjust the equalizer, gain and delayer. Herein, the compensation for frequency attenuation is to amplify the attenuated harmonic waves to retrieve the signals to original status as those shown on (a) to (b) of FIG. 3. The signals after adjusting are sent to the detecting controller 244 for accurately adjusting the equalizer and the delayer, and then the optimized video signals, such as those shown on (c) of FIG. 3, can be obtained.

Referring to FIG. 1 again, a system block for one preferred embodiment 100 in accordance with the present invention is illustrated. A transmitter module 110 receives a second set of video signals from a VGA card via a signal path 12, sending a first set of video signals via a signal path 16 in a first mode period, and sends the second set of video signals by the signal path 16 in a second mode period. In the present embodiment, the first mode period begins with an initial signal received by the transmitter module 110 to a finish command received by the transmitter module 110. The first mode period includes the statuses of power-on, transmitting reconnection, etc. The second mode period is following the first mode period till the statuses of power-off and/or disconnecting transmission. In the present embodiment, the first set of video signals include at least one set of oscillator signals having a plurality of synchronous primary signals with known frequency and same amplitude, for example, a set of high-frequency oscillator primary signals and another set of middle-frequency oscillator primary signals for being used to measure the high-frequency and middle-frequency signals affected via the transmitting cable. The plurality of synchronous primary signals mentioned above could be sine waves, triangular waves, etc.

A differential driver 120 receives the first set of video signals in the first mode period and the second set of video signals in the second mode period. The differential driver 120 sends the first set of video signals in differential type and the second set of video signals in differential type by a signal path 18. Herein, the differential driver 120 also receives a synchronous signal from the VGA card by a signal path 14. A first connector 130 receives the signals from the differential driver 120, receiving/transmitting the control signals of mouse(s)/keyboard(s) via a signal path 20 and a first transceiver 140, and sends the control signals by a transmitting cable. In the present embodiment, the first connector 130 includes an RJ-45 connector; the first transceiver 140 includes an RS485 transceiver; and the transmitting cable includes a CAT5 cable.

A differential receiver 220 receives the signals from the differential driver 120 through the first connector 130, the transmitting cable and a second connector 210, and sends the first set of video signals in single-end type and the second set of video signals in single-end type by a signal path 22. Herein, the second connector 210 receives/transmits the control signals of mouse(s)/keyboard(s) by the signal path 20 and a second transceiver 250. The second connector 210 includes an RJ-45 connector and the second transceiver 250 includes an RS485 transceiver.

A receiver module 240 receives the first set of video signals from the differential receiver 220 in the first mode period, sampling and digitalizing the first set of video signals to digital signals, compares the digital signals with a set of predetermined signals to calculate a plurality of equalizing gains for providing the differential receiver 220 by a signal path 24 to equalize and amplify a plurality of primary signals of the first set of video signals, such as RGB primary signals and the signals making 3D video. The receiver module 240 also detects the delay extents of the plurality of primary signals of the first set of video signal to calculate a plurality of delay values for providing to a delayer 230 by a signal path 26 to feed back and adjust the delay extents of the plurality of primary signals of the first set of video signals. After finishing the above-mentioned feedback and adjusting process, the receiver module 240 sends a finish command to the transmitter module 110. Herein, the transmitter module 110 changes to the second mode period from the first mode period, and sends the second set of video signals after receiving the finish command. The receiver module 240 receives the second set of video signals and sends to a displayer. Herein, the differential receiver 220 equalizes and amplifies a plurality of primary signals of the second set of video signals according to the plurality of equalizing gains, and adjusts the delay extents of the plurality of primary signals of the second set of video signals according to the plurality of delay values. The displayer also receives the synchronous signals from the differential receiver 220. In the present embodiment, the output of the delayer 230 is fed back to the receiver module 240 to be determined to whether being further adjusted by the delayer 230 or being used directly, so that the output of the delayer 230 can be adapted to the length characteristic of the transmitting cable to prevent the video signals from attenuation and distortion. For example, within 2-3 meters, the output of the delayer 230 could not need to be adjusted the delay except being equalized only to have a better quality. Judging by the feedback signal, the receiver module 240 will calculate the best gains and delay values for providing the differential receiver 220 and the delayer 230 if the feedback signal needs to be further adjusted. The final signals received by the receiver module 240 is like the original signals sent by the transmitter module 110.

Referring to FIG. 2A again, a preferred transmitter module 110 and a preferred differential driver 120 in accordance with the present invention are illustrated. A first microprocessor 112 sends a control signal via a signal path 1102 and a select signal by path 1104. A test signal controller 114 receives the control signal and sends a first set of video signals (testing signals), such as R_{T}, G_{T} and B_{T}, by a signal path 1106 in a first mode period. A switcher 116 receives the first set of video signals (R_{T}, G_{T} and B_{T}) and a second set of video signals (video input signals), such as R_{I}, G_{I} and B_{I}, from a signal path 12. The switcher 116 receives the select signal and sends the first set of video signals (R_{T}, G_{T} and B_{T}) as its outputs R_{O}, G_{O} and B_{O} in the first mode period; or sends the second set of video signals (R_{I}, G_{I} and B_{I}) as its outputs R_{O}, G_{O} and B_{O} in a second mode period. Herein, the first mode period starts from an initial command via a signal path 20 received by the transmitter module 110 to a finish command received by the transmitter module 110. The first mode period includes the statuses of power-on and/or transmitting reconnection, etc. The second mode period is following the first mode period to the statuses of power-off and/or transmitting disconnection. In the present embodiment, the first set of video signals include at least one set of oscillator signals having a plurality of synchronous primary signals with known frequency and same amplitude, for example, a set of high-frequency oscillator primary signals and a set of middle-frequency oscillator primary signals for the measurement of the high-frequency and middle-frequency signals affected by the transmitting cable. The plurality of synchronous primary signals could be sine waves, triangular waves, etc. Besides, the differential driver 120 receives the signals R_{O}, G_{O} and B_{O} from a signal path 16 and sends their corresponding differential signals R+, R−, G+, G−, B+ and B−.

Referring to FIG. 2B again, a preferred receiver module 240, a preferred differential receiver 220, and a preferred delayer 230 in accordance with the present invention are illustrated. A detecting controller 244 receives a first set of video signals, such as R_{R}, G_{R} and B_{R}, from the differential receiver 220 via a signal path 22. Herein, the first set of video signals, such as R_{R}, G_{R} and B_{R}, is the single-end signals transformed from the differential signals, such as R+, R−, G+, G−, B+ and B−, received from a signal path 18 by the differential receiver 220. The detecting controller 244 digitalizes the first set of video signals to digital signals, comparing the digital signals with a set of predetermined signals provided by a second microprocessor 242 to calculate a plurality of equalizing gains, and detects the delay extents of a plurality of primary signals R_{R}, G_{R} and B_{R} of the video signals to calculate a plurality of delay values. The second microprocessor 242 receives the plurality of equalizing gains via a signal path 2402, controlling the differential receiver 220 through a signal path 24 to equalize and amplify the plurality of primary signals R_{R}, G_{R} and B_{R} of the first set of video signals according to the plurality of equalizing gains, receiving the plurality of delay values, controlling the delayer 230 by a signal path 26 to feed back and adjust the delay extents of the plurality of primary signals R_{R}, G_{R} and B_{R} of the first set of video signals from the differential receiver 220 according to the plurality of delay values, and sends a finish command to the transmitter module 110 after finishing the above-mentioned feedback and adjusting process.

In the present embodiment, the outputs of the delayer 230, such as R_{R}, G_{R} and B_{R}, are fed back to the receiver module 240 by a feedback path 28 to be determined to whether being further adjusted by the delayer 230 or being used directly, so that the outputs of the delayer 230 can adapt the length characteristic of the transmitting cable to prevent the video signal from attenuation and distortion. For example, within 2-3 meters, the output of the delayer 230 could be unnecessary to be further adjusted except being equalized only to have a better quality. Judging with the feedback signal, the detecting controller 244 and the second microprocessor 242 will calculate the optimized gains and delay values again for providing to the differential receiver 220 and the delayer 230 if the feedback signal needs to be further adjusted. The final signals received by the receiver module 240 will be like the original signals which were sent from the transmitter module 110.

Herein, according to the present invention, the inventor would like to stress the first mode period (also called auto-tuning stage or signal-tuning mode) starts from receiving an initial signal, such as the statuses of system power-on, transmission reconnection and/or system rebooted, etc., and stops at receiving a finish command; and the second mode period (also called video signal stage or video-transmitting mode) follows the first mode period till the statuses of system power-off and/or transmission disconnection. That is, once the first mode period is changed to the second mode period, the signal-tuning processes in the first mode period will not be executed anymore during the second mode period until the transmitting cable being reconnected and/or the system being rebooted. Whereby, the processes in the second mode will not be interrupted and the transmission rate for video signals will be increased.

Although specific embodiments have been illustrated and described, it will be obvious to those skilled in the art that various modifications may be made without departing from what is intended to be limited solely by the appended claims.

What is claimed is:

1. A system for automatically tuning video signals, said system comprising:
a transmitter module, sending a first set of video signals in a first mode period, and sending a second set of video signals in a second mode period; and
a receiver module, receiving and digitalizing said first set of video signals to a plurality of digital signals, comparing said plurality of digital signals with a set of predetermined signals to calculate a plurality of equalizing gains for a differential receiver to equalize and amplify a plurality of primary signals of said first set of video signals, detecting the delay extents of said plurality of primary signals of said first set of video signals to calculate a plurality of delay values for a delayer to feed back and adjust the delay extents of said plurality of primary signals of said first set of video signals, and sending a finish command to said transmitter module,
wherein, said transmitter module changes to said second mode period from said first mode period after receiving said finish command, and said receiver module receiving said second set of video signals, wherein said differential receiver equalizes and amplifies a plurality of primary signals of said second set of video signals according to said plurality of equalizing gains, and adjusts the delay extents of said plurality of primary signals of said second set of video signals according to said plurality of delay values.

2. The system according to claim 1, wherein said transmitter module comprises:
a first microprocessor, sending a control signal and a select signal;
a test signal controller, receiving said control signal and sending said first set of video signals in said first mode period; and
a switcher, receiving said first set of video signals and said second set of video signals, wherein said switcher receives said select signal and sends said first set of video signals in said first mode period, and receives said select signal and sends said second set of video signals in said second mode period.

3. The system according to claim 1, further comprising a differential driver for receiving said first set of video signals and said second set of video signals and sending said first set of video signals in differential type and said second set of video signals in differential type.

4. The system according to claim 3, wherein said differential receiver receives said first set of video signals in differential type and said second set of video signals in differential type, and sends said first set of video signals in single-end type and said second set of video signals in single-end type.

5. The system according to claim 1, wherein said first set of video signals and said second set of video signals are transmitted through a first connector, a transmitting cable, and a second connector, wherein said first and said second connectors comprise RJ-45 connectors and said transmitting cable comprises a CAT5 cable.

6. The system according to claim 1, wherein said receiver module comprises:
a detecting controller, receiving said first set of video signals from said differential receiver and digitalizing to said plurality of digital signals, comparing said plurality of digital signals with said set of predetermined signals to calculate said plurality of equalizing gains, and detecting the delay extents of said plurality of primary signals of said first set of video signals to calculate said plurality of delay values; and
a second microprocessor, receiving said plurality of equalizing gains, controlling said differential receiver to equalize and amplify said plurality of primary signals of said first set of video signals according to said plurality of equalizing gains, receiving said plurality of delay values, controlling said delayer to feed back and adjust the delay extents of said plurality of primary signals of said first set of video signals from said differential receiver according to said plurality of delay values, and sending said finish command.

7. The system according to claim 6, wherein said detecting controller receives said second set of video signals and controls said differential receiver to equalize and amplify said second set of video signals according to said plurality of equalizing gains.

8. The system according to claim 6, wherein said detecting controller receives said second set of video signals and controls said delayer to adjust the delay extents of said second set of video signals according to said plurality of delay values.

9. The system according to claim 1, wherein said first set of video signals comprise at least one set of oscillator signals having a plurality of synchronous primary signals with known frequency and same amplitude, wherein said plurality of synchronous primary signals comprise sine waves and/or triangular waves.

10. The system according to claim 1, wherein said first mode period starts from receiving an initial signal by said transmitter module, including the statuses of system power-on, transmission reconnection and/or system rebooted and stops at receiving said finish command by said transmitter module, and said second mode period follows said first mode period till the statuses of system power-off and/or transmission disconnection, wherein all processes in said first mode period are not executed anymore during said second mode period until the statuses of transmission reconnection and/or system rebooted.

11. A method for automatically tuning video signals, said method comprising:
sending a first set of video signals by a transmitter module in a first mode period, and sending a second set of video signals by said transmitter module in a second mode period;
receiving and digitalizing said first set of video signals to a plurality of digital signals by a receiver module, comparing said plurality of digital signals with a set of predetermined signals to calculate a plurality of equalizing gains;
equalizing and amplifying a plurality of primary signals of said first set of video signals by a differential receiver according to said plurality of equalizing gains;
detecting the delay extents of said plurality of primary signals of said first set of video signals by said receiver module to calculate a plurality of delay values;
feeding back and adjusting the delay extents of said plurality of primary signals of said first set of video signals by a delayer according to said plurality of delay values; and
sending a finish command by said receiver module to said transmitter module,
wherein, said transmitter module changes to said second mode period from said first mode period after receiving said finish command, and said receiver module receiving said second set of video signals, wherein said differential receiver equalizes and amplifies a plurality of primary signals of said second set of video signals according to said plurality of equalizing gains, and adjusts the delay extents of said plurality of primary signals of said second set of video signals according to said plurality of delay values.

12. The method according to claim 11, wherein said transmitter module comprises:
a first microprocessor, sending a control signal and a select signal;
a test signal controller, receiving said control signal and sending said first set of video signals in said first mode period; and
a switcher, receiving said first set of video signals and said second set of video signals, wherein said switcher receives said select signal and sends said first set of video signals in said first mode period, and receives said select signal and sends said second set of video signals in said second mode period.

13. The method according to claim 11, further comprising receiving said first set of video signals and said second set of video signals by a differential driver, and sending said first set of video signals in differential type and said second set of video signals in differential type by said differential driver.

14. The method according to claim 13, wherein said differential receiver receives said first set of video signals in differential type and said second set of video signals in differential type, and sends said first set of video signals in single-end type and said second set of video signals in single-end type.

15. The method according to claim 11, wherein said receiver module comprises:
a detecting controller, receiving said first set of video signals from said differential receiver and digitalizing to said plurality of digital signals, comparing said plurality of digital signals with said set of predetermined signals to calculate said plurality of equalizing gains, and detecting the delay extents of said plurality of primary signals of said first set of video signals to calculate said plurality of delay values; and
a second microprocessor, receiving said plurality of equalizing gains, controlling said differential receiver to equalize and amplify said plurality of primary signals of said first set of video signals according to said plurality of equalizing gains, receiving said plurality of delay values, controlling said delayer to feed back and adjust the delay extents of said plurality of primary signals of said first set of video signals from said differential receiver according to said plurality of delay values, and sending said finish command.

16. The method according to claim 15, wherein said detecting controller receives said second set of video signals and controls said differential receiver to equalize and amplify said second set of video signals according to said plurality of equalizing gains.

17. The method according to claim 15, wherein said detecting controller receives said second set of video signals and controls said delayer to adjust the delay extents of said second set of video signals according to said plurality of delay values.

18. The method according to claim 11, wherein said first set of video signals comprise at least one set of oscillator signals having a plurality of synchronous primary signals with known frequency and same amplitude, wherein said plurality of synchronous primary signals comprise sine waves and/or triangular waves.

19. The method according to claim 11, wherein said first mode period starts from receiving an initial signal by said transmitter module, including the statuses of system power-on, transmission reconnection and/or system rebooted and stops at receiving said finish command by said transmitter module, and said second mode period follows said first mode period till the statuses of system power-off and/or transmission disconnection, wherein all processes in said first mode period are not executed anymore during said second mode period until the statuses of transmission reconnection and/or system rebooted.

20. A receiver module for automatically tuning video signal system, said receiver module comprising:
a detecting controller, receiving a first set of video signals from a differential receiver and digitalizing to a plurality of digital signals, comparing said plurality of digital signals with a set of predetermined signals to calculate a plurality of equalizing gains, and detecting the delay extents of a plurality of primary signals of said first set of video signals to calculate a plurality of delay values; and
a microprocessor, receiving said plurality of equalizing gains, controlling said differential receiver to equalize and amplify said plurality of primary signals of said first set of video signals according to said plurality of equalizing gains, receiving said plurality of delay values, controlling a delayer to feed back and adjust the delay extents of said plurality of primary signals of said first set of video signals from said differential receiver according to said plurality of delay values, and sending a finish command.

21. The receiver module according to claim 20, wherein said detecting controller receives a second set of video signals and controls said differential receiver to equalize and amplify said second set of video signals according to said plurality of equalizing gains.

22. The receiver module according to claim 20, wherein said detecting controller receives a second set of video signals and controls said delayer to adjust the delay extents of said second set of video signals according to said plurality of delay values.

23. A receiving method for automatically tuning video signal system, said receiving method comprising:
receiving a first set of video signals from a differential receiver and digitalizing to a plurality of digital signals by a detecting controller, comparing said plurality of digital signals with a set of predetermined signals to calculate a plurality of equalizing gains, and detecting the delay extents of a plurality of primary signals of said first set of video signals to calculate a plurality of delay values; and
receiving said plurality of equalizing gains by a microprocessor, controlling said differential receiver to equalize and amplify said plurality of primary signals of said first set of video signals according to said plurality of equalizing gains, receiving said plurality of delay values, controlling a delayer to feed back and adjust the delay extents of said plurality of primary signals of said first set of video signals from said differential receiver according to said plurality of delay values, and sending a finish command.

24. The receiving method according to claim 23, wherein said detecting controller receives a second set of video signals and controls said differential receiver to equalize and amplify said second set of video signals according to said plurality of equalizing gains.

25. The receiving method according to claim 23, wherein said detecting controller receives a second set of video signals and controls said delayer to adjust the delay extents of said second set of video signals according to said plurality of delay values.
